(19) United States
(12) Patent Application Publication
(10) Pub. No.: US 2013/0252855 A1
(43) Pub. Date: Sep. 26, 2013

(54) NOVEL USE OF A MILD ALKALINE AGENT IN CHEMICAL EOR

(71) Applicant: Board of Regents, The University of Texas System, Austin, TX (US)

(72) Inventors: Upali P. Weerasooriya, Austin, TX (US); Gary A. Pope, Cedar Park, TX (US); Mojdeh Delshad, Austin, TX (US)

(21) Appl. No.: 13/851,006

(22) Filed: Mar. 26, 2013

Related U.S. Application Data
(60) Provisional application No. 61/615,853, filed on Mar. 26, 2012.

(51) Int. Cl. C09K 8/58

(52) U.S. Cl. CPC C09K 8/58
USPC 507/202; 507/267; 507/261; 507/254; 507/255; 507/259; 507/225; 510/365; 510/276

(57) ABSTRACT

Aqueous compositions including a mild alkaline agent (i.e. compound of formula (I) or (V)) and a surfactant are provided. The compositions and methods of using the same are particularly useful in the field of enhanced oil recovery.

### BACKGROUND OF THE INVENTION

Enhanced Oil Recovery (abbreviated EOR) refers to techniques for increasing the amount of unrefined petroleum, or crude oil, which may be extracted from an oil reservoir (e.g. an oil field). Using EOR, 40-60% of the reservoir's original oil can typically be extracted compared with only 20-40% using primary and secondary recovery (e.g. by water injection or natural gas injection). Enhanced oil recovery may also be referred to as improved oil recovery or tertiary recovery (as opposed to primary and secondary recovery).

Enhanced oil recovery may be achieved by a variety of methods including miscible gas injection (which includes carbon dioxide flooding), chemical injection (which includes polymer flooding, alkaline flooding and surfactant flooding or any combination thereof), microbial injection, or thermal recovery (which includes cyclic steam, steam flooding, and fire flooding) or a combination of different injection methods (e.g. chemical injection and gas injection). The injection of various chemicals during chemical EOR, usually as dilute aqueous solutions, has been used to improve oil recovery. Injection of alkaline or caustic solutions into reservoirs with oil that has organic acids naturally occurring in the oil (also referred to herein as “unrefined petroleum acids”) will result in the production of soap that may lower the interfacial tension enough to increase production. Injection of a dilute solution of a water soluble polymer to increase the viscosity of the injected water can increase the amount of oil recovered from geological formations. Aqueous solutions of surfactants such as petroleum sulfonates may be injected to lower the interfacial tension or capillary pressure that impedes oil droplets from moving through a reservoir. Special formulations of oil, water and surfactant microemulsions, have also proven useful. Application of these methods is usually limited by the cost of the chemicals and their adsorption and loss onto the rock of the oil containing formation.

Some unrefined petroleum contains carboxylic acids having, for example, C₁₁ to C₂₀ alkyl chains, including napthenic acid mixtures (also referred to herein as “unrefined petroleum acids”). The recovery of such “reactive” oils may be performed using alkali agents (e.g. NaOH or Na₂CO₃) in a surfactant composition. The alkali reacts with the acid (unrefined petroleum acid) in the reactive oil to form soap. These soaps serve as an additional source of surfactants enabling the use of much lower level of surfactants initially added to effect enhanced oil recovery (EOR). However, when the available water supply is hard, the added alkali causes precipitation of cations, such as Ca⁺² or Mg⁺². In order to prevent such precipitation an expensive chelant such as EDTA may be required in the surfactant composition or expensive water softening processes may be used. Applicants have developed surfactant formulations (e.g. alkoxy carboxylate surfactants), which can be effectively used for enhanced oil recovery in the absence of alkali agents. These surfactant formulations are particularly effective at neutral pH. However, at lower pH (e.g. pH 7 or lower) the non-alkaline surfactant formulations are associated with higher adsorption of the surfactant to the rock. At a pH above 7 (e.g. 8 or 9), on the other hand, the surfactant adsorption can only be significantly reduced for these surfactant formulations by addition of alkaline agents. However, where the water supply is hard, the above mentioned precipitation of divalent cations (e.g. Ca⁺² or Mg⁺²) due to the presence of alkali agents reduces surfactant solubility and therefore efficiency of the oil recovery process. Therefore, there is a need in the art, particularly where the oil reservoir includes hard brine water, for alkali agents that increase the pH and reduce the adsorption of surfactant to the rock without causing precipitation of the Ca⁺² or Mg⁺².

The compositions and methods provided herein overcome these and other needs in the art. Therefore, the methods and compositions provided are particularly useful for cost effective enhanced oil recovery using chemical injection.

### BRIEF SUMMARY OF THE INVENTION

In one aspect, an aqueous composition is provided. The aqueous compositon includes water, a surfactant and a compound having the formula:

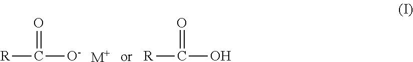

(V). In formula (I) or (V) R is unsubstituted C₁-C₄ alkyl and M⁺ is a monovalent, divalent or trivalent cation.

In another aspect, an emulsion composition is provided. The emulsion composition includes an unrefined petroleum phase and an aqueous phase. The aqueous phase includes the aqueous composition provided herein including embodiments thereof.

In another aspect, a method of displacing a hydrocarbon material in contact with a solid material is provided. The method includes contacting a hydrocarbon material with the aqueous composition provided herein including embodiments thereof. The hydrocarbon material is in contact with a solid material. The hydrocarbon material is allowed to separate from the solid material thereby displacing the hydrocarbon material in contact with the solid material.

In another aspect, a method of converting an unrefined petroleum acid into a surfactant is provided. The method inlcludes contacting a petroleum material with the aqueous composition provided herein including embodiments thereof, thereby forming an emulsion in contact with the petroleum material. An unrefined petroleum acid within the unrefined petroleum material is allowed to enter into the emulsion, thereby converting the unrefined petroleum acid into a surfactant.

### BRIEF DESCRIPTION OF THE DRAWINGS

FIG. 1: Solubilization ratios of 30% w/w oil using surfactant formulation 0.66% C₂₈-25PO-45EO carboxylate, 0.4% C₁₅₋₁₈ IOS, 0.3% C₁₉₋₂₈ IOS, 1% TEGBE (triethylene glycol mono butyl ether) and increasing levels of sodium chloride as a function of the total dissoloved solids (TDS) in hard brine after 52 days at 78° C. The aqueous limit is equivalent to 132,619 ppm TDS.

FIG. 2: Solubilization ratios of 30% w/w reactive oil using surfactant formulation 0.66% C₂₈-25PO-45EO carboxylate, 0.4% C₁₅₋₁₈ IOS, 0.3% C₁₉₋₂₈ IOS, 1% TEGBE and increasing levels of sodium acetate as a function of the total dissoloved solids (TDS) in hard brine after 45 days at 78° C. The aqueous limit is equivalent to 107,619 ppm TDS.

### DETAILED DESCRIPTION OF THE INVENTION

### Definitions

The abbreviations used herein have their conventional meaning within the chemical and biological arts.

Where substituent groups are specified by their conventional chemical formulae, written from left to right, they equally encompass the chemically identical substituents that would result from writing the structure from right to left, e.g., —CH₂O— is equivalent to —OCH₂—.

The term “alkyl,” by itself or as part of another substituent, means, unless otherwise stated, a straight (i.e. unbranched) or branched chain which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. Alkyl groups which are limited to hydrocarbon groups are termed “homoalkyl”. An alkoxy is an alkyl attached to the remainder of the molecule via an oxygen linker (—O—).

The term “alkylene” by itself or as part of another substituent means a divalent radical derived from an alkyl, as exemplified, but not limited, by —CH₂CH₂CH₂CH₂—, and further includes those groups described below as “heteroalkylene.” Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

The term “heteroalkyl,” by itself or in combination with another term, means, unless otherwise stated, a stable straight or branched chain or combinations thereof, consisting of at least one carbon atom and at least one heteroatom selected from the group consisting of O, N, P, Si and S, and wherein the nitrogen and sulfur atoms may optionally be oxidized. and the nitrogen heteroatom may optionally be quaternized. The heteroatom(s) O, N, P and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, O—CH₃, —O—CH₂—CH₃, and —CN. Up to two heteroatoms may be consecutive, such as, for example, —CH₂—NH—OCH₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′— and —R′C(O)₂—.

The terms “cycloalkyl” and “heterocycloalkyl,” by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopropyl, cyclobutyl, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like. A “cycloalkylene” and a “heterocycloalkylene,” alone or as part of another substituent means a divalent radical derived from a cycloalkyl and heterocycloalkyl, respectively.

The term “aryl” means, unless otherwise stated, a polyunsaturated, aromatic, hydrocarbon substituent which can be a single ring or multiple rings (preferably from 1 to 3 rings) which are fused together (i.e. a fused ring aryl) or linked covalently. A fused ring aryl refers to multiple rings fused together wherein at least one of the fused rings is an aryl ring. The term “heteroaryl” refers to aryl groups (or rings) that contain from one to four heteroatoms selected from N, O, and S, wherein the nitrogen and sulfur atoms are optionally oxidized, and the nitrogen atom(s) are optionally quaternized. Thus, the term “heteroaryl” includes fused ring heteroaryl groups (i.e. multiple rings fused together wherein at least one of the fused rings is a heteroaromatic ring). A 5,6-fused ring heteroarylene refers to two rings fused together, wherein one ring has 5 members and the other ring has 6 members, and wherein at least one ring is a heteroaryl ring. Likewise, a 6,6-fused ring heteroarylene refers to two rings fused together, wherein one ring has 6 members and the other ring has 6 members, and wherein at least one ring is a heteroaryl ring. And a 6,5-fused ring heteroarylene refers to two rings fused together, wherein one ring has 6 members and the other ring has 5 members, and wherein at least one ring is a heteroaryl ring. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below. An “arylene” and a “heteroarylene,” alone or as part of another substituent means a divalent radical derived from an aryl and heteroaryl, respectively.

The term “oxo” as used herein means an oxygen that is double bonded to a carbon atom.

The symbol “ [symbol] ” denotes the point of attachment of a chemical moiety to the remainder of a molecule or chemical formula.

Each R-group as provided in the formulae provided herein can appear more than once. Where a R-group appears more than once ach R group can be optionally different.

The term “contacting” as used herein, refers to materials or compounds being sufficiently close in proximity to react or interact. For example, in methods of contacting a hydrocarbon material bearing formation and/or a well bore, the term “contacting” includes placing an aqueous composition (e.g. chemical, surfactant or polymer) within a hydrocarbon material bearing formation using any suitable manner known in the art (e.g., pumping, injecting, pouring, releasing, displacing, spotting or circulating the chemical into a well, well bore or hydrocarbon bearing formation).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e. organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) and market price in comparison to light (or sweet) crude oils. Crude oil may also be characterized by its Equivalent Alkane Carbon Number (EACN).

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are more sensitive to temperature changes than the paraffin-based crudes. (iii) Mixed based crude oils contain both paraffin and naphthenes, as well as aromatic hydrocarbons. Most crude oils fit this latter category.

“Heavy crude oils” as provided herein are crude oils, with an API gravity of less than 20. The heavy crude oils may have a viscosity greater than 100 cP. In some embodiments, the heavy crude oil has a viscosity of at least 100 cP. In other embodiments, the heavy crude oil has a viscosity of at least 1,000 cP. In other embodiments, the heavy crude oil has a viscosity of at least 10,000 cP. In other embodiments, the heavy crude oil has a viscosity of at least 100,000 cP. In other embodiments, the heavy crude oil has a viscosity of at least 1,000,000 cP.

“Reactive” or “active” heavy crude oil as referred to herein is heavy crude oil containing natural organic acidic components (also referred to herein as unrefined petroleum acid) or their precursors such as esters or lactones. These reactive heavy crude oils can generate soaps (carboxylates, surfactants) when reacted with alkali or an organic base. More terms used interchangeably for heavy crude oil throughout this disclosure are hydrocarbon material or reactive petroleum material. An “oil bank” or “oil cut” as referred to herein, is the heavy crude oil that does not contain the injected chemicals and is pushed by the injected fluid during an enhanced oil recovery process.

“Unrefined petroleum acids” as referred to herein are carboxylic acids contained in active petroleum material (reactive heavy crude oil). The unrefined petroleum acids contain C₁₁ to C₂₀ alkyl chains, including napthenic acid mixtures. The recovery of such “reactive” oils may be performed using alkali (e.g. NaOH or Na₂CO₃) in a surfactant composition. The alkali reacts with the acid in the reactive oil to form soap in situ. These in situ generated soaps serve as a source of surfactants enabling efficient oil recovery from the reservoir as well as heavy crude oil transport.

The term “polymer” refers to a molecule having a structure that essentially includes the multiple repetitions of units derived, actually or conceptually, from molecules of low relative molecular mass. In some embodiments, the polymer is an oligomer.

The term “bonded” refers to having at least one of covalent bonding, hydrogen bonding, ionic bonding, Van Der Waals interactions, pi interactions, London forces or electrostatic interactions.

The term “productivity” as applied to a petroleum or oil well refers to the capacity of a well to produce hydrocarbons (e.g. unrefined petroleum); that is, the ratio of the hydrocarbon flow rate to the pressure drop, where the pressure drop is the difference between the average reservoir pressure and the flowing bottom hole well pressure (i.e., flow per unit of driving force).

The term “oil solubilization ratio” is defined as the volume of oil solubilized divided by the volume of surfactant in microemulsion. All the surfactant is presumed to be in the microemulsion phase. The oil solubilization ratio is applied for Winsor type I and type III behavior. The volume of oil solubilized is found by reading the change between initial aqueous level and excess oil (top) interface level. The oil solubilization ratio is calculated as follows:

$${σ}_{o} = \frac{{V}_{o}}{{V}_{s}} ,$$

wherein
σₒ=oil solubilization ratio;
Vₒ=volume of oil solubilized;
Vₛ=volume of surfactant.

The term “water solubilization ratio” is defined as the volume of water solubilized divided by the volume of surfactant in microemulsion. All the surfactant is presumed to be in the microemulsion phase. The water solubilization ratio is applied for Winsor type III and type II behavior. The volume of water solubilized is found by reading the change between initial aqueous level and excess water (bottom) interface level. The water solubilization parameter is calculated as follows:

$${σ}_{w} = \frac{{V}_{w}}{{V}_{s}} ,$$

wherein
σ_{w}=water solubilization ratio;
V_{w}=volume of water solubilized.

The optimum solubilization ratio occurs where the oil and water solubilization ratios are equal. The coarse nature of phase behavior screening often does not include a data point at optimum, so the solubilization ratio curves are drawn for the oil and water solubilization ratio data and the intersection of these two curves is defined as the optimum. The following is true for the optimum solubilization ratio:

σₒ=σ_{w}=σ*;
σ*=optimum solubilization ratio.

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g. precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein is the property of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick,” having a higher viscosity. More generally, the less viscous a fluid is, the greater its ease of fluidity.

The term “salinity” as used herein, refers to concentration of salt dissolved in a aqueous phases. Examples for such salts are without limitation, sodium chloride, magnesium and calcium sulfates, and bicarbonates. In more particular, the term salinity as it pertains to the present invention refers to the concentration of salts in brine and emulsions.

A “alkali agent” as provided herein is used according to its conventional meaning and refers any basic, ionic salts of alkali metals or alkaline earth metals. Examples of alkali agents useful for the present invention include, but are not limited to, sodium hydroxide, sodium carbonate, sodium silicate, sodium metaborate, and EDTA tetrasodium salt. Alkali agents as provided herein are typically capable of reacting with an unrefined petroleum acid (e.g. the acid in crude oil (reactive oil)) to form soap (a surfactant salt of a fatty acid) in situ. These in situ generated soaps serve as a source of surfactants causing a reduction of the interfacial tension of the oil in water emulsion, thereby reducing the viscosity of the emulsion.

A “co-solvent” refers to a compound having the ability to increase the solubility of a solute in the presence of an unrefined petroleum acid. In some embodiments, the co-solvents provided herein have a hydrophobic portion (alkyl or aryl chain), a hydrophilic portion (e.g. an alcohol) and optionally an alkoxy portion. Co-solvents as provided herein include alcohols (e.g. C₁-C₆ alcohols, C₁-C₆ diols), alkoxy alcohols (e.g. C₁-C₆ alkoxy alcohols, C₁-C₆ alkoxy diols, phenyl alkoxy alcohols), glycol ether, glycol and glycerol.

A “microemulsion” as referred to herein is a thermodynamically stable mixture of oil, water, and a stabilizing agents such as a surfactant or a co-solvent that may also include additional components such as alkali agents, polymers (e.g. water-soluble polymers) and a salt. In contrast, a “macroemulsion” as referred to herein is a thermodynamically unstable mixture of oil and water that may also include additional components. An “emulsion” as referred to herein may be a microemulsion or a macroemulsion.

### Aqueous Compositions

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not limit the scope of the invention.

Provided herein, inter alia, are aqueous compositions and methods of using the same for a variety of applications including enhanced oil recovery. The aqueous compositions provided herein include water, a surfactant (or a combination of multiple surfactants) and a compound of formula (I) or (V). The aqueous compositions can be used with broad oil concentrations, at a wide range of salinities and are surprisingly effective in the presence of hard brine water. The aqueous compositions provided herein may be functional at high reservoir temperatures and particularly at alkaline pH (e.g. pH 8-9). In reservoirs where hard brine water is used, the compound of the present aqueous composition may prevent surfactant precipitation and minimize surfactant adsorption to solid reservoir material (e.g. rock). Thereby the surfactant may be made readily available to react with (i.e. mobilize) the organic acids in the oil, resulting in the formation of soap that may lower the interfacial tension enough to increase oil production from the well. The compositions provided herein are useful for the recovery of active and non-active crude oils the like.

In one aspect, an aqueous composition is provided. The aqueous compositon includes water, a surfactant and a compound having the formula:

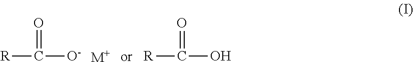

(V). In formula (I) or (V), R is unsubstituted C₁-C₄ alkyl. M⁺ is a monovalent, divalent or trivalent cation. R may be branched or unbranched unsubstituted C₁-C₄ alkyl. In some embodiments, R is unbranched unsubstituted C₁-C₄ alkyl. In some further embodiments, R is C₁-C₂ alkyl. In some embodiments, R is methyl. In some embodiments, M⁻ is Na⁺, NH₄⁺, Ca²⁺, Mg²⁺ or Ba²⁺. In some embodiments, R is methyl and M⁺ is a monovalent cation. In some further embodiments, R is methyl and M⁺ is Na⁺. Thus in some embodiments, the aqueous composition includes water, a surfactant and sodium acetate.

In some embodiments, the aqueous composition includes a plurality of compounds of formula (I) or (V). Where the aqueous composition includes a plurality of compounds of formula (I) or (V), the compounds may be independently different. For example, the aqueous composition may include a first compound where R is methyl, a second compound where R is ethyl, a third compound where R is propyl (e.g. isopropyl) and a fourth compound where R is butyl (e.g. isobutyl).

As described above, the aqueous composition provided herein includes a surfactant or a surfactant blend (e.g. a plurality of surfactant types) and a compound having formula (I) or (V). In some embodiments, the compound is present in an amount sufficient to increase the solubility of the surfactant in the aqueous composition relative to the absence of the compound. In other words, in the presence of a sufficient amount of the compound, the solubility of the surfactant in the aqueous composition is higher than in the absence of the compound. In other embodiments, the compound is present in an amount sufficient to increase the solubility of the surfactant in the aqueous composition relative to the absence of the compound. Thus, in the presence of a sufficient amount of the compound the solubility of the surfactant in the aqueous solution is higher than in the absence of the compound.

In some embodiments, the compound is present at a concentration of at least 0.01% w/w. In some embodiments, the compound is present at a concentration from about 0.01% w/w to about 15% w/w. In other embodiments, the compound is present at an amount approximately equal to or less than 10% w/w. In some embodiments, the compound is present at a concentration from about 0.01% w/w to about 15% w/w, from about 0.1% w/w to about 15% w/w, from about 1% w/w to about 15% w/w, from about 2% w/w to about 15% w/w, from about 3% w/w to about 15% w/w, from about 4% w/w to about 15% w/w, from about 5% w/w to about 15% w/w, from about 6% w/w to about 15% w/w, from about 7% w/w to about 15% w/w, from about 8% w/w to about 15% w/w, from about 9% w/w to about 15% w/w, from about 10% w/w to about 15% w/w, from about 11% w/w to about 15% w/w, from about 12% w/w to about 15% w/w, from about 13% w/w to about 15% w/w, from about 14% w/w to about 15% w/w, from about 0.01% w/w to about 14% w/w, from about 0.1% w/w to about 14% w/w, from about 1% w/w to about 14% w/w, from about 2% w/w to about 14% w/w, from about 3% w/w to about 14% w/w, from about 4% w/w to about 14% w/w, from about 5% w/w to about 14% w/w, from about 6% w/w to about 14% w/w, from about 7% w/w to about 14% w/w, from about 8% w/w to about 14% w/w, from about 9% w/w to about 14% w/w, from about 10% w/w to about 14% w/w, from about 11% w/w to about 14% w/w, from about 12% w/w to about 14% w/w, from about 13% w/w to about 14% w/w, from about 0.01% w/w to about 13% w/w, from about 0.1% w/w to about 13% w/w, from about 1% w/w to about 13% w/w, from about 2% w/w to about 13% w/w, from about 3% w/w to about 13% w/w, from about 4% w/w to about 13% w/w, from about 5% w/w to about 13% w/w, from about 6% w/w to about 13% w/w, from about 7% w/w to about 13% w/w, from about 8% w/w to about 13% w/w, from about 9% w/w to about 13% w/w, from about 10% w/w to about 13% w/w, from about 11% w/w to about 13% w/w, or from about 12% w/w to about 13% w/w.

In some embodiments, the compound is present at a concentration from about 0.01% w/w to about 12% w/w, from about 0.1% w/w to about 12% w/w, from about 1% w/w to about 12% w/w, from about 2% w/w to about 12% w/w, from about 3% w/w to about 12% w/w, from about 4% w/w to about 12% w/w, from about 5% w/w to about 12% w/w, from about 6% w/w to about 12% w/w, from about 7% w/w to about 12% w/w, from about 8% w/w to about 12% w/w, from about 9% w/w to about 12% w/w, from about 10% w/w to about 12% w/w, from about 11% w/w to about 12% w/w, from about 0.01% w/w to about 11% w/w, from about 0.1% w/w to about 11% w/w, from about 1% w/w to about 11% w/w, from about 2% w/w to about 11% w/w, from about 3% w/w to about 11% w/w, from about 4% w/w to about 11% w/w, from about 5% w/w to about 11% w/w, from about 6% w/w to about 11% w/w, from about 7% w/w to about 11% w/w, from about 8% w/w to about 11% w/w, from about 9% w/w to about 11% w/w, from about 10% w/w to about 11% w/w, from about 0.01% w/w to about 10% w/w, from about 0.1% w/w to about 10% w/w, from about 1% w/w to about 10% w/w, from about 2% w/w to about 10% w/w, from about 3% w/w to about 10% w/w, from about 4% w/w to about 10% w/w, from about 5% w/w to about 10% w/w, from about 6% w/w to about 10% w/w, from about 7% w/w to about 10% w/w, from about 8% w/w to about 10% w/w, from about 9% w/w to about 10% w/w, from about 0.01% w/w to about 9% w/w, from about 0.1% w/w to about 9% w/w, from about 1% w/w to about 9% w/w, from about 2% w/w to about 9% w/w, from about 3% w/w to about 9% w/w, from about 4% w/w to about 9% w/w, from about 5% w/w to about 9% w/w, from about 6% w/w to about 9% w/w, from about 7% w/w to about 9% w/w, from about 8% w/w to about 9% w/w, from about 0.01% w/w to about 8% w/w, from about 0.1% w/w to about 8% w/w, from about 1% w/w to about 8% w/w, from about 2% w/w to about 8% w/w, from about 3% w/w to about 8% w/w, from about 4% w/w to about 8% w/w, from about 5% w/w to about 8% w/w, from about 6% w/w to about 8% w/w, from about 7% w/w to about 8% w/w, from about 0.01% w/w to about 7% w/w, from about 0.1% w/w to about 7% w/w, from about 1% w/w to about 7% w/w, from about 2% w/w to about 7% w/w, from about 3% w/w to about 7% w/w, from about 4% w/w to about 7% w/w, from about 5% w/w to about 7% w/w, or from about 6% w/w to about 7% w/w.

In some embodiments, the compound is present at a concentration from about 0.01% w/w to about 6% w/w, from about 0.1% w/w to about 6% w/w, from about 1% w/w to about 6% w/w, from about 2% w/w to about 6% w/w, from about 3% w/w to about 6% w/w, from about 4% w/w to about 6% w/w, from about 5% w/w to about 6% w/w, from about 0.01% w/w to about 5% w/w, from about 0.1% w/w to about 5% w/w, from about 1% w/w to about 5% w/w, from about 2% w/w to about 5% w/w, from about 3% w/w to about 5% w/w, from about 4% w/w to about 5% w/w, from about 0.01% w/w to about 4% w/w, from about 0.1% w/w to about 4% w/w, from about 1% w/w to about 4% w/w, from about 2% w/w to about 4% w/w, from about 3% w/w to about 4% w/w, from about 0.01% w/w to about 3% w/w, from about 0.1% w/w to about 3% w/w, from about 1% w/w to about 3% w/w, from about 2% w/w to about 3% w/w, from about 0.01% w/w to about 2% w/w, from about 0.1% w/w to about 2% w/w, from about 1% w/w to about 2% w/w, from about 0.01% w/w to about 1% w/w, from about 0.1% w/w to about 1% w/w, or from about 0.01% w/w to about 0.1% w/w. In some embodiments, the compound is present at a concentration from about 0.01% w/w, 0.1% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, or 15% w/w. A person of ordinary skill in the art will immediately recognize that the above referenced values refer to weight percent of compound per weight of aqueous composition.

The aqueous composition provided herein including embodiments thereof includes a surfactant. The surfactant provided herein may be any appropriate surfactant useful in the field of enhanced oil recovery. In some embodiments, the surfactant is a single surfactant type in the aqueous composition. In other embodiments, the surfactant is a surfactant blend. A “surfactant blend” as provided herein is a mixture of a plurality of surfactant types. In some embodiments, the surfactant blend includes a first surfactant type, a second surfactant type or a third surfactant type. The first, second and third surfactant type may be independently different (e.g. anionic or cationic surfactants; or two cationic surfactant having a different hydrocarbon chain length but are otherwise the same). Thus, the aqueous composition may include a first surfactant, a second surfactant and a third surfactant, wherein the first surfactant is chemically different from the second and the third surfactant, and the second surfactant is chemically different from the third surfactant. Therefore, a person having ordinary skill in the art will immediately recognize that the terms “surfactant” and “surfactant type(s)” have the same meaning and can be used interchangeably. In some embodiments, the surfactant is an anionic surfactant, a non-ionic surfactant, a zwitterionic surfactant or a cationic surfactant. In some embodiments, the surfactant is an anionic surfactant, a non-ionic surfactant, or a cationic surfactant. In other embodiments, the co-surfactant is a zwitterionic surfactant. “Zwitterionic” or “zwitterion” as used herein refers to a neutral molecule with a positive (or cationic) and a negative (or anionic) electrical charge at different locations within the same molecule. Examples for zwitterionics are without limitation betains and sultains.

The surfactant provided herein may be any appropriate anionic surfactant. In some embodiments, the surfactant is an anionic surfactant. In some embodiments, the anionic surfactant is an anionic surfactant blend. Where the anionic surfactant is an anionic surfactant blend the aqueous composition includes a plurality (i.e. more than one) of anionic surfactant types. In some embodiments, the anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant. An “alkoxy carboxylate surfactant” as provided herein is a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In some embodiments, the alkoxy carboxylate surfactant has the formula:

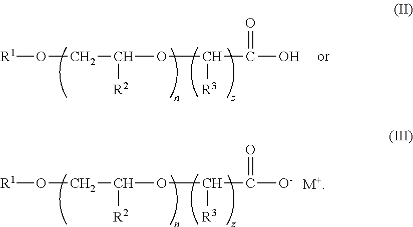

In formula (II) or (III) R¹ is substituted or unsubstituted C₈-C₁₅₀ alkyl or substituted or unsubstituted aryl, R² is independently hydrogen or unsubstituted C₁-C₆ alkyl, R³ is independently hydrogen or unsubstituted C₁-C₆ alkyl, n is an integer from 2 to 210, z is an integer from 1 to 6 and M⁻ is a monovalent, divalent or trivalent cation. In some embodiments, R¹ is unsubstituted linear or branched C₈-C₃₆ alkyl. In some embodiments, R¹ is (C₆H₅—CH₂CH₂)₃C₆H₂-(TSP), (C₆H₅—CH₂CH₂)₂C₆H₃— (DSP), (C₆H₅—CH₂CH₂)₁C₆H₄— (MSP), or substituted or unsubstituted naphthyl. In some embodiments, the alkoxy carboxylate is C₂₈-25PO-25EO-carboxylate (i.e. unsubstituted C₂₈ alkyl attached to 25 —CH₂—CH(methyl)-O-linkers, attached in turn to 25-CH₂—CH₂—O— linkers, attached in turn to —COO⁻or acid or salt thereof including metal cations such as sodium).

In some embodiments, the surfactant is an alkoxy sulfate surfactant. An alkoxy sulfate surfactant as provided herein is a surfactant having an alkyl or aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In some embodiment, the alkoxy sulfate surfactant has the formula R^{A}—(BO)ₑ—(PO)_{f}-(EO)_{g}—SO₃⁻ or acid or salt (including metal cations such as sodium) thereof, wherein R^{A} is C₈-C₃₀ alkyl, BO is —CH₂—CH(ethyl)-O—, PO is —CH₂—CH(methyl)-O—, and EO is —CH₂—CH₂—O—. The symbols e, f and g are integers from 0 to 25 wherein at least one is not zero. In some embodiment, the alkoxy sulfate surfactant is C₁₅-13PO-sulfate (i.e. an unsubstituted C₁₅ alkyl attached to 13 —CH₂—CH(methyl)-O— linkers, in turn attached to —SO₃⁻ or acid or salt thereof including metal cations such as sodium).

In other embodiments, the alkoxy sulfate surfactant has the formula

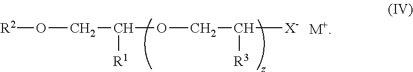

In formula (IV) R¹ and R² are independently substituted or unsubstituted C₈-C₁₅₀ alkyl or substituted or unsubstituted aryl. R³ is independently hydrogen or unsubstituted C₁-C₆ alkyl. z is an integer from 2 to 210. X⁻ is

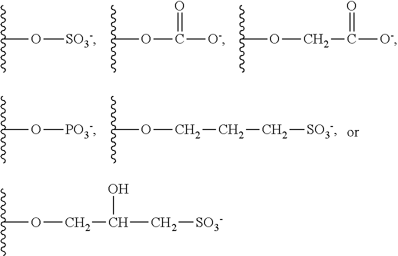

and M⁺ is a monovalent, divalent or trivalent cation. In some embodiments, R¹ is branched unsubstituted C₈-C₁₅₀. In other embodiments, R¹ is branched or linear unsubstituted C₁₂-C₁₀₀ alkyl, (C₆H₅—CH₂CH₂)₃C₆H₂-(TSP), (C₆H₅—CH₂CH₂)₂C₆H₃— (DSP), (C₆H₅—CH₂CH₂)₁C₆H₄— (MSP), or substituted or unsubstituted naphthyl. In some embodiments, the alkoxy sulfate is C₁₆-C₁₆-epoxide-15PO-10EO-sulfate (i.e. a linear unsubstituted C₁₆ alkyl attached to an oxygen, which in turn is attached to a branched unsubstituted C₁₋₆ alkyl, which in turn is attached to 15 —CH₂—CH(methyl)-O— linkers, in turn attached to 10 —CH₂—CH₂—O— linkers, in turn attached to —SO₃⁻ or acid or salt thereof including metal cations such as sodium.

The alkoxy sulfate surfactant provided herein may be an aryl alkoxy sulfate surfactant. An aryl alkoxy surfactant as provided herein is an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In some embodiments, the aryl alkoxy sulfate surfactant is (C₆H₅—CH₂CH₂)₃C₆H₂-7PO-10EO-sulfate (i.e. tri-styrylphenol attached to 7 —CH₂—CH(methyl)-O— linkers, in turn attached to 10 —CH₂—CH₂—O— linkers, in turn attached to —SO₃⁻ or acid or salt thereof including metal cations such as sodium).

In some embodiments, the surfactant is an unsubstituted alkyl sulfate or an unsubstituted alkyl sulfonate surfactant. An alkyl sulfate surfactant as provided herein is a surfactant having an alkyl group attached to —O—SO₃⁻ or acid or salt thereof including metal cations such as sodium. An alkyl sulfonate surfactant as provided herein is a surfactant having an alkyl group attached to —SO₃⁻ or acid or salt thereof including metal cations such as sodium. In some embodiments, the surfactant is an unsubstituted aryl sulfate surfactant or an unsubstituted aryl sulfonate surfactant. An aryl sulfate surfactant as provided herein is a surfactant having an aryl group attached to —O—SO₃⁻ or acid or salt thereof including metal cations such as sodium. An aryl sulfonate surfactant as provided herein is a surfactant having an aryl group attached to —SO₃⁻ or acid or salt thereof including metal cations such as sodium. In some embodiments, the surfactant is an alkyl aryl sulfonate. Non-limiting examples of alkyl sulfate surfactants, aryl sulfate surfactants, alkyl sulfonate surfactants, aryl sulfonate surfactants and alkyl aryl sulfonate surfactants useful in the embodiments provided herein are alkyl aryl sulfonates (ARS) (e.g. alkyl benzene sulfonate (ABS)), alkane sulfonates, petroleum sulfonates, and alkyl diphenyl oxide (di)sulfonates. Additional surfactants useful in the embodiments provided herein are alcohol sulfates, alcohol phosphates, alkoxy phosphate, sulfosuccinate esters, alcohol ethoxylates, alkyl phenol ethoxylates, quaternary ammonium salts, betains and sultains.

The surfactant as provided herein may be an olefin sulfonate surfactant. In some embodiments, the olefin sulfonate surfactant is an internal olefin sulfonate (IOS) or an alfa olefin sulfonate (AOS). In some embodiments, the olefin sulfonate surfactant is a C₁₀-C₃₀ (IOS). In some further embodiments, the olefin sulfonate surfactant is C₁₅-C₁₈ IOS. In other embodiments, the olefin sulfonate surfactant is C₁₉-C₂₈ IOS. Where the olefin sulfonate surfactant is C₁₅-C₁₈ IOS, the olefin sulfonate surfactant is a mixture (combination) of C₁₅, C₁₆, C₁₇ and C₁₈ alkene, wherein each alkene is attached to a —SO₃⁻ or acid or salt thereof including metal cations such as sodium. Likewise, where the olefin sulfonate surfactant is C₁₉-C₂₈ IOS, the olefin sulfonate surfactant is a mixture (combination) of C₁₉, C₂₀, C₂₁ C₂₂, C₂₃, C₂₄, C₂₅, C₂₆, C₂₇ and C₂₈ alkene, wherein each alkene is attached to a —SO₃⁻ or acid or salt thereof including metal cations such as sodium. As mentioned above, the aqueous composition provided herein may include a plurality of surfactants (i.e. a surfactant blend). In some embodiments, the surfactant blend includes a first olefin sulfonate surfactant and a second olefin sulfonate surfactant. In some further embodiments, the first olefin sulfonate surfactant is C₁₅-C₁₈ IOS and the second olefin sulfonate surfactant is C₁₉-C₂₈ IOS.

Useful surfactants are disclosed, for example, in U.S. Pat. Nos. 3,811,504, 3,811,505, 3,811,507, 3,890,239, 4,463,806, 6,022,843, 6,225,267, 7,629,299; WIPO Patent Application WO/2008/079855, WO/2012/027757 and WO /2011/094442; as well as U.S. Patent Application Nos. 2005/0199395, 2006/0185845, 2006/018486, 2009/0270281, 2011/0046024, 2011/0100402, 2011/0190175, 2007/0191633, 2010/004843. 2011/0201531, 2011/0190174, 2011/0071057, 2011/0059873, 2011/0059872, 2011/0048721, 2010/0319920, and 2010/0292110. Additional useful surfactants are surfactants known to be used in enhanced oil recovery methods, including those discussed in D. B. Levitt, A. C. Jackson, L. Britton and G. A. Pope, “Identification and Evaluation of High-Performance EOR Surfactants,” SPE 100089, conference contribution for the SPE Symposium on Improved Oil Recovery Annual Meeting, Tulsa, Okla., Apr. 24-26, 2006.

A person having ordinary skill in the art will immediately recognize that many surfactants are commercially available as blends of related molecules (e.g. IOS and ABS surfactants). Thus, where a surfactant is present within a composition provided herein, a person of ordinary skill would understand that the surfactant may be a blend of a plurality of related surfactant molecules (as described herein and as generally known in the art).

In some embodiment, the total surfactant concentration (i.e. the total amount of all surfactant types within the aqueous compositions and emulsion compositions provided herein) in is from about 0.05% w/w to about 10% w/w. In other embodiments, the total surfactant concentration in the aqueous composition is from about 0.25% w/w to about 10% w/w. In other embodiments, the total surfactant concentration in the aqueous composition is about 0.5% w/w. In other embodiments, the total surfactant concentration in the aqueous composition is about 1.0% w/w. In other embodiments, the total surfactant concentration in the aqueous composition is about 1.25% w/w. In other embodiments, the total surfactant concentration in the aqueous composition is about 1.5% w/w. In other embodiments, the total surfactant concentration in the aqueous composition is about 1.75% w/w. In other embodiments, the total surfactant concentration in the aqueous composition is about 2.0% w/w. In other embodiments, the total surfactant concentration in the aqueous composition is about 2.5% w/w. In other embodiments, the total surfactant concentration in the aqueous composition is about 3.0% w/w. In other embodiments, the total surfactant concentration in the aqueous composition is about 3.5% w/w. In other embodiments, the total surfactant concentration in the aqueous composition is about 4.0% w/w. In other embodiments, the total surfactant concentration in the aqueous composition is about 4.5% w/w. In other embodiments, the total surfactant concentration in the aqueous composition is about 5.0% w/w. In other embodiments, the total surfactant concentration in the aqueous composition is about 5.5% w/w. In other embodiments, the total surfactant concentration in the aqueous composition is about 6.0% w/w. In other embodiments, the total surfactant concentration in the aqueous composition is about 6.5% w/w. In other embodiments, the total surfactant concentration in the aqueous composition is about 7.0% w/w. In other embodiments, the total surfactant concentration in the aqueous composition is about 7.5% w/w. In other embodiments, the total surfactant concentration in the aqueous composition is about 8.0% w/w. In other embodiments, the total surfactant concentration in the aqueous composition is about 9.0% w/w. In other embodiments, the total surfactant concentration in the aqueous composition is about 10% w/w. In embodiments, the total surfactant concentration in the aqueous composition is about 0.05% w/w, 0.25% w/w, 0.5% w/w, 1.25% w/w, 1.5% w/w, 1.75% w/w, 2.0% w/w, 2.5% w/w, 3.0% w/w, 3.5% w/w, 4.5% w/w, 4.5% w/w, 5.0% w/w, 5.5% w/w, 6.0% w/w, 6.5% w/w, 7.0% w/w, 7.5% w/w, 8.0% w/w, 8.5% w/w or 10% w/w. In embodiments, the total surfactant concentration in the aqueous composition is about 1.6% w/w. In another embodiment, the total surfactant concentration in the aqueous composition is about 0.66% w/w. In another embodiment, the total surfactant concentration in the aqueous composition is about 0.4% w/w. A person of ordinary skill in the art will immediately recognize that the above referenced values refer to weight percent of compound per weight of aqueous composition.

In some embodiments, the aqueous composition further includes an alkali agent. An alkali agent as provided herein is a basic, ionic salt of an alkali metal (e.g. lithium, sodium, potassium) or alkaline earth metal element (e.g. magnesium, calcium, barium, radium). In some embodiments, the alkali agent is NaOH, KOH, LiOH, Na₂CO₃, NaHCO₃, Na-metaborate, Na silicate, Na orthosilicate, or NH₄OH. The aqueous composition may include seawater, or fresh water from an aquifer, river or lake. In some embodiments, the aqueous composition includes hard brine water or soft brine water. In some further embodiments, the water is soft brine water. In some further embodiments, the water is hard brine water. Where the aqueous composition includes soft brine water, the aqueous composition may include an alkaline agent. In soft brine water the alkaline agent provides for enhanced soap generation from the active oils, lower surfactant adsorption to the solid material (e.g. rock) in the reservoir and increased solubility of viscosity enhancing water soluble polymers. The alkali agent is present in the aqueous composition at a concentration from about 0.1% w/w to about 10% w/w. The combined amount of alkali agent and compound of formula (I) or (V) present in the aqueous composition provided herein is approximately equal to or less than about 10% w/w.

In some embodiments, the amount of alkali agent is from about 0.1% w/w to about 10% w/w. In some embodiments, the amount of alkali agent is from about 0.1% w/w to about 9.5% w/w. In some embodiments, the amount of alkali agent is from about 0.1% w/w to about 9% w/w. In some embodiments, the amount of alkali agent is from about 0.1% w/w to about 8.5% w/w. In some embodiments, the amount of alkali agent is from about 0.1% w/w to about 8% w/w. In some embodiments, the amount of alkali agent is from about 0.1% w/w to about 7.5% w/w. In some embodiments, the amount of alkali agent is from about 0.1% w/w to about 7% w/w. In some embodiments, the amount of alkali agent is from about 0.1% w/w to about 6.5% w/w. In some embodiments, the amount of alkali agent is from about 0.1% w/w to about 6% w/w. In some embodiments, the amount of alkali agent is from about 0.1% w/w to about 5.5% w/w. In some embodiments, the amount of alkali agent is from about 0.1% w/w to about 5% w/w. In some embodiments, the amount of alkali agent is from about 0.1% w/w to about 4.5% w/w. In some embodiments, the amount of alkali agent is from about 0.1% w/w to about 4% w/w. In some embodiments, the amount of alkali agent is from about 0.1% w/w to about 3.5% w/w. In some embodiments, the amount of alkali agent is from about 0.1% w/w to about 3% w/w. In some embodiments, the amount of alkali agent is from about 0.1% w/w to about 2.5% w/w. In some embodiments, the amount of alkali agent is from about 0.1% w/w to about 2% w/w. In some embodiments, the amount of alkali agent is from about 0.1% w/w to about 1.5% w/w. In some embodiments, the amount of alkali agent is from about 0.1% w/w to about 1% w/w. In some embodiments, the amount of alkali agent is from about 0.1% w/w to about 0.5% w/w. In one embodiment, the alkali agent is present at about 10% w/w, 9.5% w/w, 9% w/w, 8.5% w/w, 8% w/w, 7.5% w/w, 7% w/w, 6.5% w/w, 6% w/w, 5.5% w/w, 5% w/w, 4.5% w/w, 4% w/w, 3.5% w/w, 3% w/w, 2.5% w/w, 2% w/w, 1.5% w/w, 1% w/w, 0.5% w/w, or 0.1% w/w.

The aqueous composition provided herein may further include a viscosity enhancing water soluble polymer. In some embodiments, the water-soluble polymer may be a biopolymer such as xanthan gum or scleroglucan, a synthetic polymer such as polyacryamide, hydrolyzed polyarcrylamide or co-polymers of acrylamide and acrylic acid, 2-acrylamido 2-methyl propane sulfonate or N-vinyl pyrrolidone, a synthetic polymer such as polyethylene oxide, or any other high molecular weight polymer soluble in hard brine water or soft brine water. In some embodiments, the polymer is polyacrylamide (PAM), partially hydrolyzed polyacrylamides (HPAM), and copolymers of 2-acrylamido-2-methylpropane sulfonic acid or sodium salt or mixtures thereof, and polyacrylamide (PAM) commonly referred to as AMPS copolymer and mixtures of the copolymers thereof. In some embodiments, the viscosity enhancing water soluble polymer is polyacrylamide or a co-polymer of polyacrylamide. Molecular weights of the polymers may range from about 10,000 daltons to about 20,000,000 daltons. In one embodiment, the viscosity enhancing water-soluble polymer is a partially (e.g. 20%, 25%, 30%, 35%, 40%, 45%) hydrolyzed anionic polyacrylamide. In some further embodiment, the viscosity enhancing water-soluble polymer has a molecular weight of approximately about 8×10⁶. In some other further embodiment, the viscosity enhancing water-soluble polymer has a molecular weight of approximately about 18×10⁶. Non-limiting examples of commercially available polymers useful for the invention including embodiments provided herein are Florpaam 3330S and Florpaam 3360S. In some embodiments, the viscosity enhancing water-soluble polymer is used in the range of about 500 to about 5000 ppm concentration, such as from about 1000 to 2000 ppm (e.g. in order to match or exceed the reservoir oil viscosity under the reservoir conditions of temperature and pressure).

In some embodiments, the compound is present in an amount sufficient to increase the solubility of the viscosity enhancing water soluble polymer in the aqueous composition relative to the absence of the compound. In other words, in the presence of a sufficient amount of the compound, the solubility of the viscosity enhancing water soluble polymer in the aqueous composition is higher than in the absence of the compound. In other embodiments, the compound is present in an amount sufficient to increase the solubility of the viscosity enhancing water soluble polymer in the aqueous composition relative to the absence of the compound. Thus, in the presence of a sufficient amount of the compound the solubility of the viscosity enhancing water soluble polymer in the aqueous solution is higher than in the absence of the compound.

The aqueous compositions provided herein may further include a gas. For instance, the gas may be combined with the aqueous composition to reduce its mobility by decreasing the liquid flow in the pores of the solid material (e.g. rock). In some embodiments, the gas may be supercritical carbon dioxide, nitrogen, natural gas or mixtures of these and other gases.

In some embodiments, the aqueous composition further includes a co-solvent. In some embodiments, the co-solvent is an alcohol, alcohol ethoxylate, glycol ether, glycols, or glycerol. In some embodiments, the aqueous composition includes water, a surfactant, a compound of formula (I) or (V) and a co-solvent. The aqueous compositions provided herein may include more than one co-solvent. Thus, in one embodiment, the aqueous composition includes a plurality of different co-solvents. Where the aqueous composition includes a plurality of different co-solvents, the different co-solvents can be distinguished by their chemical (structural) properties. For example, the aqueous composition may include a first co-solvent, a second co-solvent and a third co-solvent, wherein the first co-solvent is chemically different from the second and the third co-solvent, and the second co-solvent is chemically different from the third co-solvent. In one embodiment, the plurality of different co-solvents includes at least two different alcohols (e.g. a C₁-C₆ alcohol and a C₁-C₄ alcohol). In one embodiment, the aqueous composition includes a C₁-C₆ alcohol and a C₁-C₄ alcohol. In other embodiments, the plurality of different co-solvents includes at least two different alkoxy alcohols (e.g. a C₁-C₆ alkoxy alcohol and a C₁-C₄ alkoxy alcohol). In other embodiments, the aqueous composition includes a C₁-C₆ alkoxy alcohol and a C₁-C₄ alkoxy alcohol. In one embodiment, the plurality of different co-solvents includes at least two co-solvents selected from the group consisting of alcohols, alkyl alkoxy alcohols and phenyl alkoxy alcohols. For example, the plurality of different co-solvents may include an alcohol and an alkyl alkoxy alcohol, an alcohol and a phenyl alkoxy alcohol, or an alcohol, an alkyl alkoxy alcohol and a phenyl alkoxy alcohol. The alkyl alkoxy alcohols or phenyl alkoxy alcohols provided herein have a hydrophobic portion (alkyl or aryl chain), a hydrophilic portion (e.g. an alcohol) and optionally an alkoxy (ethoxylate or propoxylate) portion. Thus, in some embodiments, the co-solvent is an alcohol, alkoxy alcohol, glycol ether, glycol or glycerol.

In some embodiments, the co-solvent has the formula

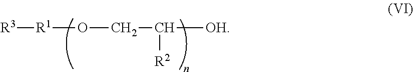

In formula (VI), R¹ is unsubstituted C₁-C₆ alkylene, unsubstituted phenylene, unsubstituted cyclohexylene, unsubstituted cyclopentylene or methyl-substituted cyclopentylene. R² is independently hydrogen, methyl or ethyl. R³ is independently hydrogen or

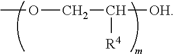

R⁴ is independently hydrogen, methyl or ethyl, n is an integer from 0 to 30, and m is an integer from 0 to 30. In one embodiment, n is an integer from 0 to 25. In one embodiment, n is an integer from 0 to 20. In one embodiment, n is an integer from 0 to 15. In one embodiment, n is an integer from 0 to 10. In one embodiment, n is an integer from 0 to 5. In one embodiment, n is 1. In other embodiments, n is 3. In one embodiment, n is 5. In one embodiment, m is an integer from 0 to 25. In one embodiment, m is an integer from 0 to 20. In one embodiment, m is an integer from 0 to 15. In one embodiment, m is an integer from 0 to 10. In one embodiment, m is an integer from 0 to 5. In one embodiment, m is 1. In other embodiments, m is 3. In one embodiment, m is 5. In formula (I) each of R² and R⁴ can appear more than once and can be optionally different. For example, in one embodiment where n is 2, R² appears twice and can be optionally different. In other embodiments, where m is 3, R⁴ appears three times and can be optionally different.

R¹ may be linear or branched unsubstituted alkylene. In one embodiment, R¹ of formula (VI) is linear unsubstituted C₁-C₆ alkylene. In one embodiment, R¹ of formula (VI) is branched unsubstituted C₁-C₆ alkylene. In other embodiments, R¹ of formula (VI) is linear unsubstituted C₂-C₆ alkylene. In other embodiments, R¹ of formula (VI) is branched unsubstituted C₂-C₆ alkylene. In other embodiments, R¹ of formula (VI) is linear unsubstituted C₃-C₆ alkylene. In other embodiments, R¹ of formula (VI) is branched unsubstituted C₃-C₆ alkylene. In other embodiments, R¹ of formula (VI) is linear unsubstituted C₄-C₆ alkylene. In other embodiments, R¹ of formula (VI) is branched unsubstituted C₄-C₆ alkylene. In other embodiments, R¹ of formula (VI) is linear unsubstituted C₄-alkylene. In other embodiments, R¹ of formula (VI) is branched unsubstituted C₄-alkylene.

In one embodiment, where R¹ is linear or branched unsubstituted alkylene (e.g. branched unsubstituted C₁-C₆ alkylene), the alkylene is a saturated alkylene (e.g. a linear or branched unsubstituted saturated alkylene or branched unsubstituted C₁-C₆ saturated alkylene). A “saturated alkylene,” as used herein, refers to an alkylene consisting only of hydrogen and carbon atoms that are bonded exclusively by single bonds. Thus, in one embodiment, R¹ is linear or branched unsubstituted saturated alkylene. In one embodiment, R¹ of formula (VI) is linear unsubstituted saturated C₁-C₆ alkylene. In one embodiment, R¹ of formula (VI) is branched unsubstituted saturated C₁-C₆ alkylene. In other embodiments, R¹ of formula (VI) is linear unsubstituted saturated C₂-C₆ alkylene. In other embodiments, R¹ of formula (VI) is branched unsubstituted saturated C₂-C₆ alkylene. In other embodiments, R¹ of formula (VI) is linear unsubstituted saturated C₃-C₆ alkylene. In other embodiments, R¹ of formula (VI) is branched unsubstituted saturated C₃-C₆ alkylene. In other embodiments, R¹ of formula (VI) is linear unsubstituted saturated C₄-C₆ alkylene. In other embodiments, R¹ of formula (VI) is branched unsubstituted saturated C₄-C₆ alkylene. In other embodiments, R¹ of formula (VI) is linear unsubstituted saturated C₄-alkylene. In other embodiments, R¹ of formula (VI) is branched unsubstituted saturated C₄-alkylene.

In one embodiment, R¹ of formula (VI) is substituted or unsubstituted cycloalkylene or unsubstituted arylene. In one embodiment, R¹ of formula (VI) is R⁷-substituted or unsubstituted cyclopropylene, wherein R⁷ is C₁-C₃ alkyl. In other embodiments, R¹ of formula (VI) is R⁸-substituted or unsubstituted cyclobutylene, wherein R⁸ is C₁-C₂ alkyl. In other embodiments, R¹ of formula (VI) is R⁹-substituted or unsubstituted cyclopentylene, wherein R⁹ is C₁-alkyl. In other embodiments, R¹ of formula (VI) is R¹⁰-substituted or unsubstituted cyclopentylene, wherein R¹⁰ is unsubstituted cyclohexyl. In one embodiment, R¹ of formula (VI) is unsubstituted phenylene, unsubstituted cyclohexylene, unsubstituted cyclopentylene or methyl-substituted cyclopentylene.

In one embodiment, —R¹-R³ of formula (VI) is C₁-C₆ alkyl, unsubstituted phenyl, unsubstituted cyclohexyl, unsubstituted cyclopentyl or a methyl-substituted cycloalkyl.

In one embodiment, the co-solvent has the structure of formula

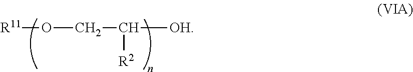

In formula (IA), R¹¹ is C₁-C₆ alkyl, unsubstituted phenyl, unsubstituted cyclohexyl, unsubstituted cyclopentyl or a methyl-substituted cycloalkyl.

In one embodiment, n and m are independently 1 to 20. In other embodiments, n and m are independently 1 to 15. In other embodiments, n and m are independently 1 to 10. In one embodiment, n and m are independently 1 to 6. In one embodiment, n and m are independently 1.

The co-solvent included in the aqueous compositions provided herein may be a monohydric or a dihydric alkoxy alcohol (e.g. C₁-C₆ alkoxy alcohol or C₁-C₆ alkoxy diol). Where the co-solvent is a monohydric alcohol, the co-solvent has the formula (VI) and R³ is hydrogen. Where the co-solvent is a diol, the co-solvent has the formula (VI) and R³ is

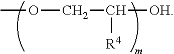

In one embodiment, R¹ is linear unsubstituted C₄ alkylene and n is 3. In one embodiment, the co-solvent is triethyleneglycol butyl ether. In other embodiments, the co-solvent is tetraethylene glycol. In further embodiments, m is 3. In one embodiment, R¹ is linear unsubstituted C₄ alkylene and n is 5. In one embodiment, the co-solvent is pentaethyleneglycol n-butyl ether. In further embodiments, m is 5. In one embodiment, R¹ is branched unsubstituted C₄ alkylene and n is 1. In one embodiment, the co-solvent is ethyleneglycol iso-butyl ether. In further embodiments, m is 1. In one embodiment, R¹ is branched unsubstituted C₄ alkylene and n is 3. In one embodiment, the co-solvent is triethyleneglycol iso-butyl ether. In further embodiments, m is 3. In one embodiment, the co-solvent is ethylene glycol or propylene glycol. In other embodiments, the co-solvent is ethylene glycol alkoxylate or propylene glycol alkoxylate. In one embodiment, the co-solvent is propylene glycol diethoxylate or propylene glycoltriethoxylate. In one embodiment, the co-solvent is propylene glycol tetraethoxylate.

In the structure of formula (VI), R³ may be hydrogen or

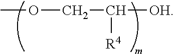

Thus in one embodiment, R³ is

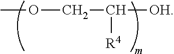

In one embodiment, the co-solvent provided herein may be an alcohol or diol (C₁-C₆ alcohol or C₁-C₆ diol). Where the co-solvent is an alcohol, the co-solvent has a structure of formula (I), where R³ is hydrogen and n is 0. Where the co-solvent is a diol, the co-solvent has a structure of formula (VI), where R³ is

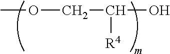

and n and m are 0. Thus, in one embodiment, n and m are independently 0. In one embodiment, R¹ is linear or branched unsubstituted C₁-C₆ alkylene. In other embodiments, R¹ is linear or branched unsubstituted C₂-C₆ alkylene. In one embodiment, R¹ is linear or branched unsubstituted C₂-C₆ alkylene. In one embodiment R¹ is linear or branched unsubstituted C₃-C₆ alkylene. In other embodiments, R¹ is linear or branched unsubstituted C₄-C₆ alkylene. In one embodiment, R¹ is linear or branched unsubstituted C₄-alkylene. In one embodiment, R¹ is branched unsubstituted butylene. In one embodiment, the co-solvent has the structure of formula

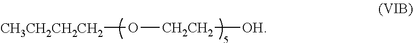

In other embodiments, the co-solvent has the structure of formula

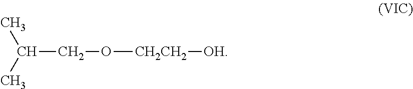

In one embodiment, the co-solvent has the structure of formula

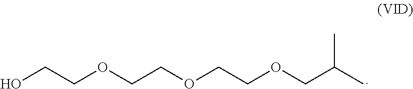

The structure of formula (VID) is also referred to herein as triethylene glycol mono butyl ether (TEGBE). In some embodiments, the co-solvent is TEGBE (triethylene glycol mono butyl ether). In some embodiments, TEGBE is present at a concentration from about 0.01% to about 2%. In some embodiments, TEGBE is present at a concentration from about 0.05% to about 1.5%. In some embodiments, TEGBE is present at a concentration from about 0.2% to about 1.25%. In some embodiments, TEGBE is present at a concentration from about 0.25% to about 1%. In some embodiments, TEGBE is present at a concentration from about 0.5% to about 0.75%. In some embodiments, TEGBE is present at a concentration of about 0.25%. In other embodiments, TEGBE is present at a concentration of about 1%.

The aqueous composition provided herein may include water, the compound of formula (I) or (V), a plurality of surfactants (i.e. a surfactant blend including for example a first surfactant, a second surfactant and a third surfactant) and a co-solvent. Thus, in some embodiments, the aqueous composition includes a compound of formula (I), wherein R is methyl and M⁺ is sodium (i.e. sodium acetate), present at about 5% w/w; a surfactant of formula (II), wherein R¹ is 28, n is 50 and R² is independently methyl and hydrogen, and R³ is hydrogen, present at about 0.66% w/w (i.e. C₂₈-25PO-25EO-carboxylate); a C₁₅-C₁₈ internal olefin sulfonate surfactant, present at about 0.4% w/w; a C₁₉-C₂₈ internal olefin sulfonate surfactant, present at about 0.3% w/w and a co-solvent of formula (IVD), present at about 1% w/w. In some further embodiments, the aqueous composition includes a plurality of compounds having formula (I) or (V).

The aqueous composition may include more than 10 ppm of divalent cations combined. In some embodiments, the aqueous composition includes more than 10 ppm of Ca²⁺ and Mg²⁺ combined. The aqueous composition may include more than 100 ppm of divalent cations combined. In some embodiments, the aqueous composition includes more than 1000 ppm of Ca²⁺ and Mg²′ combined. In some embodiments, the aqueous composition includes more than 3000 ppm of Ca²⁺ and Mg²⁺ combined.

In some embodiments, the aqueous composition includes more than 10 ppm of hardness ions such as polyvalent (e.g. divalent) cations. In other embodiments, the aqueous composition includes more than 100 ppm of hardness ions such as polyvalent (e.g. divalent) cations. In some embodiments, the aqueous composition includes more than 1000 ppm of hardness ions such as polyvalent (e.g. divalent) cations. In some embodiments, the divalent cations are Ba²⁺, Fe²⁺, Ca²⁺ and Mg²⁺. The term “hardness ions” as used herein refers to multivalent ions causing water hardness.

In some embodiments, the aqueous composition has a pH of less than about 9.5. In other embodiments, the aqueous composition has a pH of less than about 9.0. In other embodiments, the aqueous composition has a pH of less than about 8.5. In other embodiments, the aqueous composition has a pH of less than about 8. In other embodiments, the aqueous composition has a pH of less than about 7.5. in one embodiment the aqueous composition has a pH of at least 7. In other embodiments, the aqueous composition has a pH of less than about 10.0. In other embodiments, the aqueous composition has a pH of less than about 11.0. In other embodiments, the aqueous composition has a pH of less than about 12.0.

In some embodiments, the aqueous composition has a salinity of at least 5,000 ppm. In other embodiments, the aqueous composition has a salinity of at least 50,000 ppm. In other embodiments, the aqueous composition has a salinity of at least 150,000 ppm. The total range of salinity (total dissolved solids in the brine) is 100 ppm to saturated brine (about 260,000 ppm). The aqueous composition may include seawater, brine or fresh water from an aquifer, river or lake. The aqueous combination may further include salt to increase the salinity. In some embodiments, the salt is NaCl, KCl, CaCl₂, or MgCl₂.

In another aspect, an emulsion composition is provided. The emulsion composition includes an unrefined petroleum phase, an aqueous phase, a surfactant and a compound having the formula:

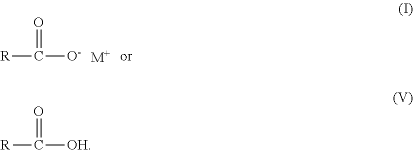

The emulsion includes the aqueous composition provided herein including embodiments thereof (e.g. an aqueous composition wherein the compound of formula (I) is sodium acetate, the first surfactant is C₂₈-25PO-25EO-carboxylate, the second surfactant is C₁₅-C₁₈ IOS, the third surfactant is C₁₉-C₂₈ IOS).

The emulsion composition therefore may further include a co-solvent. Thus in some embodiments, the emulsion further includes a co-solvent. In some further embodiment, the co-solvent is TEGBE. For example, in some embodiments, the emulsion further includes an alkali agent (e.g. NaOH, Na₂CO₃, or NH₄OH). Thus, in some embodiments, the emulsion composition includes an alkali agent. In some embodiments, the emulsion includes a viscosity enhancing water soluble polymer. In other embodiments, the emulsion includes a gas.

In some embodiments, the components of the emulsion include the components, and amounts thereof, set forth above in the description of the aqueous solution. The emulsion composition provided herein may include a combination of one or more surfactants (i.e. a surfactant blend including for example, a first, a second and a third surfactant). For example, in some embodiments the emulsion composition includes an alkoxy carboxylate surfactant, and one or more internal olefin sulfonate surfactants. In some embodiments, the compound is present in an amount sufficient to increase the solubility of the surfactant in the aqueous phase relative to the absence of the compound. In other words, in the presence of a sufficient amount of the compound (e.g. formula (I) or (V) and embodiments thereof), the solubility of the surfactant in the emulsion composition is higher than in the absence of the compound. In other embodiments, the compound is present in an amount sufficient to increase the solubility of the surfactant in the emulsion composition (e.g. in the aqueous phase) relative to the absence of the compound. Thus, in the presence of a sufficient amount of the compound the solubility of the surfactant in the emulsion composition is higher than in the absence of the compound (e.g. the surfactant does not precipitate out of the emulsion or aqueous phase).

In some embodiments, the emulsion composition is a microemulsion. A “microemulsion” as referred to herein is a thermodynamically stable mixture of oil, water and surfactants that may also include additional components such as co-solvents, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein the surfactant forms aggregates (e.g. micelles) where the hydrophilic part of the surfactant molecule contacts the aqueous phase of the emulsion and the lipophilic part contacts the oil phase of the emulsion. Thus, in some embodiments, the surfactant forms part of the aqueous part of the emulsion. And in other embodiments, the surfactant forms part of the oil phase of the emulsion. In yet another embodiment, the surfactant forms part of an interface between the aqueous phase and the oil phase of the emulsion.

In other embodiments, the oil and water solubilization ratios are insensitive to the combined concentration of divalent metal cations (e.g. Ca⁺² and Mg⁺²) within the emulsion composition. In other embodiments, the oil and water solubilization ratios are insensitive to the salinity of the water or to all of the specific electrolytes contained in the water. The term “insensitive” used in the context of this paragraph means that the solubilization ratio tends not to change (e.g. tends to remain approximately constant) as the concentration of divalent metal cations and/or salinity of water changes. In some embodiments, the change in the solubilization ratios are less than 5%, 10%, 20%, 30%, 40%, or 50% over a divalent metal cation concentration range of 10 ppm, 100 ppm, 1000 ppm or 10,000 ppm. In another embodiment, the change in the solubilization ratios are less than 5%, 10%, 20%, 30%, 40%, or 50% over a salinity concentration range of 10 ppm, 100 ppm, 1000 ppm or 10,000 ppm.

In another aspect, a method of displacing a hydrocarbon material in contact with a solid material is provided. The method includes contacting a hydrocarbon material with the aqueous composition provided herein (e.g. an aqueous composition, wherein the compound of formula (I) is sodium acetate, the first surfactant is C₂₈-25PO-25EO-carboxylate, the second surfactant is C₁₅-C₁₈ IOS, the third surfactant is C₁₉-C₂₈ IOS and the co-solvent is TEGBE) including embodiments thereof. The hydrocarbon material is in contact with a solid material. The hydrocarbon material is allowed to separate from the solid material thereby displacing the hydrocarbon material in contact with the solid material. In some embodiments, the solid material is contacted with the aqueous composition. A “hydrocarbon material,” as provided herein, is a hydrophobic material containing alkyl (hydrocarbon) chains. As described above the compound may be present in the aqueous composition (or emulsion composition) in an amount sufficient to increase the solubility of the surfactant. Thus, in some embodiments, the compound is present in an amount sufficient to increase the solubility of the surfactant relative to the absence of the compound. In other embodiments, the compound is present in an amount sufficient to decrease the adsorption of the surfactant to the solid material.

In other embodiments, the hydrocarbon material is unrefined petroleum (e.g. in a petroleum reservoir). The solid material may be a natural solid material (i.e. a solid found in nature such as rock). The natural solid material may be found in a petroleum reservoir. In some embodiments, the method is an enhanced oil recovery method. Enhanced oil recovery methods are well known in the art. A general treatise on enhanced oil recovery methods is Basic Concepts in Enhanced Oil Recovery Processes edited by M. Baviere (published for SCI by Elsevier Applied Science, London and New York, 1991). For example, in an enhanced oil recovery method, the displacing of the unrefined petroleum in contact with the solid material is accomplished by contacting the unrefined with an aqueous composition provided herein (e.g. an aqueous composition wherein the compound of formula (I) is sodium acetate, the first surfactant is C₂₈-25PO-25EO-carboxylate, the second surfactant is C₁₅-C₁₈ IOS, the third surfactant is C₁₉-C₂₈ IOS and the co-solvent is TEGBE), wherein the unrefined petroleum is in contact with the solid material. The unrefined petroleum may be in an oil reservoir. The aqueous composition provided herein is pumped into the reservoir in accordance with known enhanced oil recovery parameters. The aqueous composition provided herein may be pumped into the reservoir and, upon contacting the unrefined petroleum, form an emulsion composition provided herein.

In some embodiments, the natural solid material is rock or regolith. The natural solid material may be a geological formation such as clastics or carbonates. The natural solid material may be either consolidated or unconsolidated material or mixtures thereof. The hydrocarbon material may be trapped or confined by “bedrock” above or below the natural solid material. The hydrocarbon material may be found in fractured bedrock or porous natural solid material. In other embodiments, the regolith is soil.

In some embodiments, an emulsion forms after the contacting. The emulsion thus formed may be the emulsion composition as described above. In some embodiments, the method includes allowing an unrefined petroleum acid within the unrefined petroleum material to enter into the emulsion (e.g. emulsion composition), thereby converting the unrefined petroleum acid into a surfactant. In other words, where the unrefined petroleum acid converts into a surfactant it is mobilized and therefore separates from the solid material.

In another aspect, a method of converting an unrefined petroleum acid into a surfactant is provided. The method inlcludes contacting a petroleum material with the aqueous composition provided herein (e.g. an aqueous composition wherein the compound of formula (I) is sodium acetate, the first surfactant is C₂₈-25PO-25EO-carboxylate, the second surfactant is C₁₅-C₁₈ IOS, the third surfactant is C₁₉-C₂₈ IOS and the co-solvent is TEGBE) including embodiments thereof, thereby forming an emulsion in contact with the petroleum material. An unrefined petroleum acid within the unrefined petroleum material is allowed to enter the emulsion, thereby converting (e.g. mobilizing) the unrefined petroleum acid into a surfactant. In some embodiments, the reactive petroleum material is in a petroleum reservoir. In some embodiments, as described above and as is generally known in the art, the unrefined petroleum acid is a naphthenic acid. In some embodiments, as described above and as is generally known in the art, the unrefined petroleum acid is a mixture of naphthenic acid.

### EXAMPLES

The following examples are meant to provide detailed embodiments only and are not meant to limit the scope of the disclosure provided herein in any way.

### Examples of Aqueous Compositions

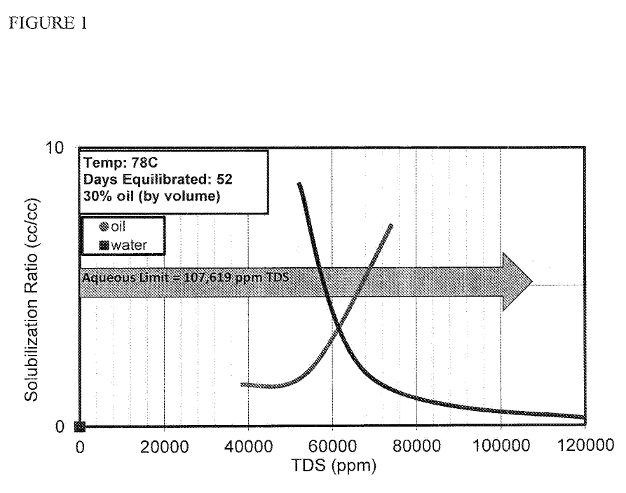

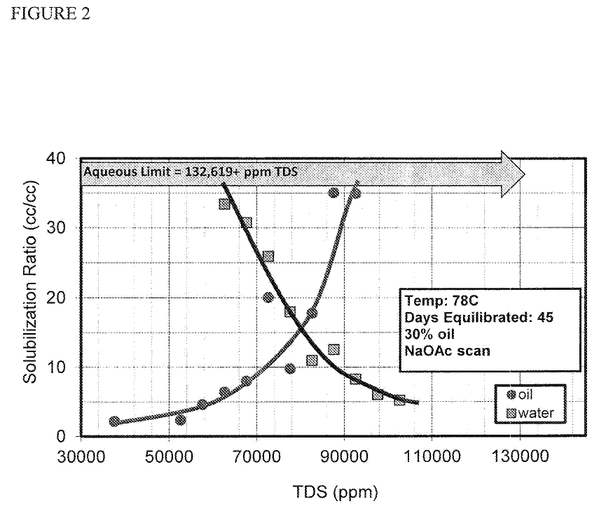

FIGS. 1 and 2 disclose examples of aqueous compositions useful for the recovery of reactive and non-reactive oils. Depending, inter alia, on the conditions in the reservoir (e.g. temperature) or the nature of the oil (e.g. viscosity) the aqueous composition may include different combinations of surfactant and compound of formula (I) or (V) at various concentrations.

FIG. 1 shows the oil and water solubilization ratios of 30% w/w oil using surfactant formulation 0.66% C₂₈-25PO-45EO carboxylate, 0.4% C₁₅₋₁₈ IOS, 0.3% C₁₉₋₂₈ IOS, 1% TEGBE and increasing levels of sodium chloride. In this experiment the solubilization ratio optimum is reached at approximately 60.000 ppm TDS i.e. at a sodium chloride concentration of approximately 3% w/w (30.000 ppm).

FIG. 2 shows the oil and water solubilization ratios of 30% w/w oil using surfactant formulation 0.66% C₂₈-25PO-45EO carboxylate, 0.4% C₁₅₋₁₈ IOS, 0.3% C₁₉₋₂₈ IOS, 1% TEGBE and increasing levels of sodium acetate. In this experiment the solubilization ratio optimum is reached at approximately 80.000 ppm TDS i.e. at a sodium acetate concentration of approximately 5% w/w (50.000 ppm). Both, FIG. 1 and FIG. 2 show optimum solubilization ratios bigger than 10 cc/cc resulting in systems with ultra-low interfacial tension, which is highly desirable for EOR.

Table 1 summarizes the composition of the brine used during the experimental procedures provided herein (FIGS. 1 and 2).

| | ppm |
|---|---|
| Na+ | 9,917 |
| K+ | 343 |
| Ca2+ | 479 |
| Mg2+ | 1,250 |
| Sr2+ | 9 |
| Cl− | 19,891 |
| TDS | 31,889 |

### EMBODIMENTS

### Embodiment 1

An aqueous composition comprising water, a surfactant and a compound having the formula:

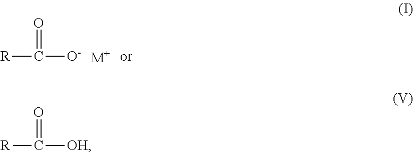

wherein R is unsubstituted C₁-C₄ alkyl; and M⁺ is a monovalent, divalent or trivalent cation.

### Embodiment 2

The aqueous composition of embodiment 1, wherein R is unbranched unsubstituted C₁-C₄ alkyl.

### Embodiment 3

The aqueous composition of embodiment 1 or 2, wherein R is unsubstituted C₁-C₂ alkyl.

### Embodiment 4

The aqueous composition of any one of embodiments 1-3, wherein M⁺ is Na⁺, K⁺, NH₄⁺, Ca²⁺, Mg²⁺ or Ba²⁺.

### Embodiment 5

The aqueous composition of any one of embodiments 1-4, wherein said compound is present at a concentration of at least 0.1% w/w.

### Embodiment 6

The aqueous composition of any one of embodiments 1-5, wherein said surfactant is an anionic surfactant, a non-ionic surfactant, zwitterionic surfactant or a cationic surfactant.

### Embodiment 7

The aqueous composition of embodiment 6, wherein said anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant.

### Embodiment 8

The aqueous composition of any one of embodiments 1-7, wherein said compound is present in an amount sufficient to increase the solubility of said surfactant in said aqueous composition relative to the absence of said compound.

### Embodiment 9

The aqueous composition of embodiment 8, wherein said surfactant is an anionic surfactant.

### Embodiment 10

The aqueous composition of any one of embodiments 1-9, further comprising a co-solvent.

### Embodiment 11

The aqueous composition of embodiment 10, wherein said co-solvent is triethylene glycol mono butyl ether (TEGBE).

### Embodiment 12

The aqueous composition of embodiment 11, wherein TEGBE is present at a concentration of about 1% w/w.

### Embodiment 13

The aqueous composition of any one of embodiments 1-12, further comprising an alkali agent.

### Embodiment 14

The aqueous composition of embodiment 13, wherein said alkali agent is NaOH, KOH, LiOH, Na₂CO₃, NaHCO₃, Na-metaborate, Na silicate, Na orthosilicate, or NH₄OH.

### Embodiment 15

The aqueous composition of embodiment 13, wherein said water is hard brine water.

### Embodiment 16

The aqueous composition of any one of embodiments 1-15, further comprising a viscosity enhancing water soluble polymer.

### Embodiment 17

The aqueous composition of embodiment 16, wherein said viscosity enhancing water soluble polymer is polyacrylamide or a co-polymer of polyacrylamide.

### Embodiment 18

The aqueous composition of embodiment 16, wherein said compound is present in an amount sufficient to increase the solubility of said viscosity enhancing water soluble polymer in said aqueous composition relative to the absence of said compound.

### Embodiment 19

The aqueous composition of any one of embodiments 1-18, further comprising a gas.

### Embodiment 20

The aqueous composition of any one of embodiments 1-19, comprising more than 10 ppm of Ca²⁺ and Mg²⁺ combined.

### Embodiment 21

The aqueous composition of any one of embodiments 1-20, comprising more than 100 ppm of Ca²⁺ and Mg²⁺ combined.

### Embodiment 22

The aqueous composition of any one of embodiments 1-21, comprising more than 1000 ppm of Ca²⁺ and Mg²⁺ combined.

### Embodiment 23

The aqueous composition of any one of embodiments 1-22, having a pH of less than 9.5.

### Embodiment 24

The aqueous composition of any one of embodiments 1-23, having a salinity of at least 5,000 ppm.

### Embodiment 25

The aqueous composition of any one of embodiments 1-24, having a salinity of at least 50,000 ppm.

### Embodiment 26

The aqueous composition of any one of embodiments 1-25, having a salinity of at least 150,000 ppm.

### Embodiment 27

An emulsion composition comprising an unrefined petroleum phase, an aqueous phase, a surfactant and a compound having the formula:

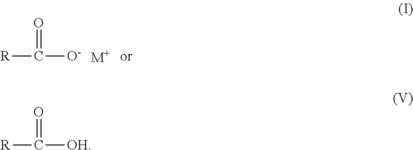

### Embodiment 28

The emulsion composition of embodiment 27, wherein said compound is present in an amount sufficient to increase the solubility of said surfactant in said emulsion relative to the absence of said compound.

### Embodiment 29

The emulsion composition of embodiment 27 or 28, wherein said emulsion composition is a microemulsion.

### Embodiment 30

The emulsion composition of any one of embodiments 27-29, further comprising a co-solvent.

### Embodiment 31

The emulsion composition of any one of embodiments 27-30, further comprising an alkali agent.

### Embodiment 32

The emulsion composition of any one of embodiments 27-31, further comprising a viscosity enhancing water soluble polymer.

### Embodiment 33

The emulsion composition of any one of embodiments 27-32, further comprising a gas.

### Embodiment 34

The emulsion composition of any one of embodiments 27-33, wherein the oil and water solubilization ratios are insensitive to the combined concentration of Ca2+ and Mg2+ combined within the aqueous phase.

### Embodiment 35

The emulsion composition of any one of embodiments 27-34, wherein the oil and water solubilization ratios are insensitive to the salinity of the water within the aqueous phase.

### Embodiment 36

A method of displacing a hydrocarbon material in contact with a solid material, said method comprising: (i) contacting a hydrocarbon material with the aqueous composition of one of embodiments 1 to 26, wherein said hydrocarbon material is in contact with a solid material; (ii) allowing said hydrocarbon material to separate from said solid material thereby displacing said hydrocarbon material in contact with said solid material.

### Embodiment 37

The method of embodiment 36, further comprising contacting said solid material with said aqueous composition.

### Embodiment 38

The method of embodiment 36 or 37, wherein said compound is present in an amount sufficient to increase the solubility of said surfactant relative to the absence of said compound.

### Embodiment 39

The method of any one of embodiments 36-38, wherein said compound is present in an amount sufficient to decrease the adsorption of said surfactant to said solid material.

### Embodiment 40

The method of any one of embodiments 36-39, wherein said hydrocarbon material is unrefined petroleum in a petroleum reservoir and said solid material is a natural solid material in a petroleum reservoir.

### Embodiment 41

The method of any one of embodiments 36-40, wherein said method is an enhanced oil recovery method.

### Embodiment 42

The method of any one of embodiments 36-41, wherein said solid material is regolith or rock.

### Embodiment 43

The method of embodiment 42, wherein said regolith is soil.

### Embodiment 44

The method of embodiment 43, wherein said soil is petroleum contaminated soil.

### Embodiment 45

The method of embodiment 44, wherein said method is an environmental oil spill clean-up method.

### Embodiment 46

The method of embodiment 36, wherein said hydrocarbon material is oil and said solid material is textile material.

### Embodiment 47

The method of embodiment 46, wherein said method is a textile cleaning method.

### Embodiment 48

The method of embodiment 36, wherein said hydrocarbon material is oil and said solid material is a household surface.

### Embodiment 49

The method of embodiment 48, wherein said method is a household cleaning method.

### Embodiment 50

A method of converting an unrefined petroleum acid into a surfactant, said method comprising: contacting a petroleum material with the aqueous composition of one of embodiments 1 to 26, thereby forming an emulsion in contact with said petroleum material; allowing an unrefined petroleum acid within said unrefined petroleum material to enter into said emulsion, thereby converting said unrefined petroleum acid into a surfactant.

### Embodiment 51

The method of embodiment 50, wherein said compound is sodium acetate and said surfactant is an alkoxy carboxylate surfactant.

1. An aqueous composition comprising water, a surfactant and a compound having the formula: 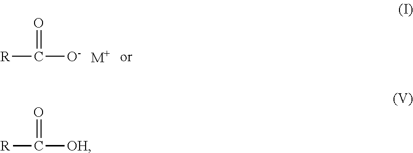
wherein
R is unsubstituted C₁-C₄ alkyl;
and M⁺ is a monovalent, divalent or trivalent cation.

2. The aqueous composition of claim 1, wherein R is unbranched unsubstituted C₁-C₄ alkyl.

3. The aqueous composition of claim 2, wherein R is unsubstituted C₁-C₂ alkyl.

4. The aqueous composition of claim 1, wherein M⁺ is Na⁺, K⁺, NH₄⁺, Ca²⁺, Mg²⁺ or Ba²⁺.

5. The aqueous composition of claim 1, wherein said compound is present at a concentration of at least 0.1% w/w.

6. The aqueous composition of claim 1, wherein said surfactant is an anionic surfactant, a non-ionic surfactant, zwitterionic surfactant or a cationic surfactant.

7. The aqueous composition of claim 6, wherein said anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant.

8. The aqueous composition of claim 1, wherein said compound is present in an amount sufficient to increase the solubility of said surfactant in said aqueous composition relative to the absence of said compound.

9. The aqueous composition of claim 8, wherein said surfactant is an anionic surfactant.

10. The aqueous composition of claim 1, further comprising a co-solvent.

11. The aqueous composition of claim 10, wherein said co-solvent is triethylene glycol mono butyl ether (TEGBE).

12. The aqueous composition of claim 11, wherein TEGBE is present at a concentration of about 1% w/w.

13. The aqueous composition of claim 1, further comprising an alkali agent.

14. The aqueous composition of claim 13, wherein said alkali agent is NaOH, KOH, LiOH, Na₂CO₃, NaHCO₃, Na-metaborate, Na silicate, Na orthosilicate, or NH₄OH.

15. The aqueous composition of claim 13, wherein said water is hard brine water.

16. The aqueous composition of claim 1, further comprising a viscosity enhancing water soluble polymer.

17. The aqueous composition of claim 16, wherein said viscosity enhancing water soluble polymer is polyacrylamide or a co-polymer of polyacrylamide.

18. The aqueous composition of claim 16, wherein said compound is present in an amount sufficient to increase the solubility of said viscosity enhancing water soluble polymer in said aqueous composition relative to the absence of said compound.

19. The aqueous composition of claim 1, further comprising a gas.

20. The aqueous composition of claim 1, comprising more than 10 ppm of Ca²⁺ and Mg²⁺ combined.

21. The aqueous composition of claim 1, comprising more than 100 ppm of Ca²⁺ and Mg²⁺ combined.

22. The aqueous composition of claim 1, comprising more than 1000 ppm of Ca²⁺ and Mg²⁺ combined.

23. The aqueous composition of claim 1, having a pH of less than 9.5.

24. The aqueous composition of claim 1, having a salinity of at least 5,000 ppm.

25. The aqueous composition of claim 1, having a salinity of at least 50,000 ppm.

26. The aqueous composition of claim 1, having a salinity of at least 150,000 ppm.

27. An emulsion composition comprising an unrefined petroleum phase, an aqueous phase, a surfactant and a compound having the formula:

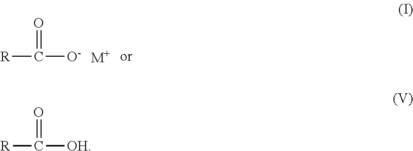

28. The emulsion composition of claim 27, wherein said compound is present in an amount sufficient to increase the solubility of said surfactant in said emulsion relative to the absence of said compound.

29. The emulsion composition of claim 27, wherein said emulsion composition is a microemulsion.

30. The emulsion composition of claim 27, further comprising a co-solvent.

31. The emulsion composition of claim 27, further comprising an alkali agent.

32. The emulsion composition of claim 27, further comprising a viscosity enhancing water soluble polymer.

33. The emulsion composition of claim 27, further comprising a gas.

34. The emulsion composition of claim 27, wherein the oil and water solubilization ratios are insensitive to the combined concentration of Ca²⁺ and Mg²⁺ combined within the aqueous phase.

35. The emulsion composition of claim 27, wherein the oil and water solubilization ratios are insensitive to the salinity of the water within the aqueous phase.

36. A method of displacing a hydrocarbon material in contact with a solid material, said method comprising:
(i) contacting a hydrocarbon material with the aqueous composition of claim 1, wherein said hydrocarbon material is in contact with a solid material;
(ii) allowing said hydrocarbon material to separate from said solid material thereby displacing said hydrocarbon material in contact with said solid material.

37. The method of claim 36, further comprising contacting said solid material with said aqueous composition.

38. The method of claim 37, wherein said compound is present in an amount sufficient to increase the solubility of said surfactant relative to the absence of said compound.

39. The method of claim 37, wherein said compound is present in an amount sufficient to decrease the adsorption of said surfactant to said solid material.

40. The method of claim 36, wherein said hydrocarbon material is unrefined petroleum in a petroleum reservoir and said solid material is a natural solid material in a petroleum reservoir.

41. The method of claim 40, wherein said method is an enhanced oil recovery method.

42. The method of claim 36, wherein said solid material is regolith or rock.

43. The method of claim 42, wherein said regolith is soil.

44. The method of claim 43, wherein said soil is petroleum contaminated soil.

45. The method of claim 44, wherein said method is an environmental oil spill clean-up method.

46. The method of claim 36, wherein said hydrocarbon material is oil and said solid material is textile material.

47. The method of claim 46, wherein said method is a textile cleaning method.

48. The method of claim 36, wherein said hydrocarbon material is oil and said solid material is a household surface.

49. The method of claim 48, wherein said method is a household cleaning method.

50. A method of converting an unrefined petroleum acid into a surfactant, said method comprising:
(i) contacting a petroleum material with the aqueous composition of claim 1, thereby forming an emulsion in contact with said petroleum material;
(ii) allowing an unrefined petroleum acid within said unrefined petroleum material to enter into said emulsion, thereby converting said unrefined petroleum acid into a surfactant.

51. The method of claim 50, wherein said compound is sodium acetate and said surfactant is an alkoxy carboxylate surfactant.
